(19) United States
(12) Patent Application Publication
(10) Pub. No.: US 2008/0248184 A1
(43) Pub. Date: Oct. 9, 2008

(54) Methods for Inhibiting Benzene Formation in Beverages and Beverages Produced Thereby

(75) Inventors: Emilien Louis Joseph Esteve, Bruxelles (BE); Bruno Van Gompel, Heusden (BE)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 12/047,455

(22) Filed: Mar. 13, 2008

Related U.S. Application Data
(60) Provisional application No. 60/894,924, filed on Mar. 15, 2007.

(51) Int. Cl. A23F 3/16; A23L 2/02

(52) U.S. Cl. 426/597; 426/599

(57) ABSTRACT

Methods of inhibiting benzene formation in beverages and beverages produced thereby are provided. The beverages provided have lower amounts of preservatives than observed in the prior art, reduced rates of benzene formation, improved flavor, and adequate protection against microbial proliferation. More particularly, the beverages provided comprise a food grade chelating agent in an amount from about 100 ppm to up to less than about 300 ppm; a preservative selected from the group consisting of sorbic acid, benzoic acid, alkali metal salts thereof, and mixtures thereof; and a beverage base comprising a fruit juice and/or tea solids.

### CROSS REFERENCE TO RELATED APPLICATIONS

This application claims priority under 35 U.S.C. § 119(e) to U.S. Provisional Application 60/894,924 filed on Mar. 15, 2007, the disclosure of which is expressly incorporated by reference in its entirety.

### FIELD OF THE INVENTION

The present disclosure relates to methods for inhibiting benzene formation in beverages. More specifically, the present disclosure relates to methods of inhibiting benzene formation in beverages comprising benzoic acid as a preservative.

### BACKGROUND OF THE INVENTION

Microbial growth and subsequent food spoilage may result from the accidental inoculation of the beverage products with food spoilage microorganisms (e.g., bacteria or yeast) during the manufacturing or packaging processes. Accordingly, the preparation of beverages having improved microbial stability is an ongoing concern with beverage manufacturers.

Microbial proliferation in beverages currently is controlled using a number of different approaches. Manufacturers often rely on the use of preservatives to provide a level of protection against microbial proliferation in beverages. Preservatives commonly used in beverage products (e.g., sorbates, benzoates, and organic acids) often contribute an off-flavor to the beverages when present at levels necessary to provide adequate protection against microbial proliferation at ambient temperatures.

Preservatives comprising benzoic acid salts, however, have been shown to interact with ascorbic acid to produce benzene in a reaction that is believed to be catalyzed by polyvalent metal ions (e.g., iron, copper, etc.). Gardner and Lawrence, J. Agric. Food Chem. 41(5) 693-95 (1993). Benzene is a well-known carcinogen and its content in the environment and food products is thoroughly monitored and regulated. For example, guidelines established by the World Health Organization, United States Environmental Protection Agency, and European Union limit the amount of benzene in drinking water to 10 ppb, 5 ppb, and 1 ppb, respectively.

Accordingly, the prevention of benzene formation in beverages has become an industry wide issue. Thus, there is a need for a cost-effective method for both inhibiting benzene formation in beverages while also preventing microbial proliferation in beverages stored at ambient temperatures.

### SUMMARY OF THE INVENTION

A beverage is provided comprising a food grade chelating agent in an amount from about 100 ppm to up to less than about 300 ppm; a preservative selected from the group consisting of sorbic acid, benzoic acid, alkali metal salts thereof, and combinations thereof, in an amount from about 50 ppm to about 4000 ppm; and a beverage base. In one particular embodiment, the beverage base comprises a fruit juice. In an alternative embodiment, the beverage base comprises tea solids.

In a particular embodiment, the food grade chelating agent may be selected from the group consisting of sodium hexametaphosphate, potassium hexametaphosphate, ethylenediaminetetraacetic acid, glucorono delta-lactone, salts of gluconic acid, and combinations thereof.

Objects and advantages of the invention will be set forth in part in the following description, or may be obvious from the description, or may be learned through practice of the invention. Unless otherwise defined, all technical and scientific terms and abbreviations used herein have the same meaning as commonly understood by one of ordinary skill in the art to which this invention pertains. Although methods and compositions similar or equivalent to those described herein can be used in the practice of the present invention, suitable methods and compositions are described without intending that any such methods and compositions limit the invention herein.

### DETAILED DESCRIPTION OF THE INVENTION

Embodiments of the present invention generally provide beverages having both improved flavor and sufficient levels of protection against microbial proliferation. The beverages comprise lower amounts of preservatives than observed in the prior art, have reduced rates of benzene formation, have improved flavor, and have adequate protection against microbial proliferation. In embodiments, the beverages are filled using clean fill lines, thereby minimizing the microbial load of the bottled beverages.

### I. Beverages

In a particular embodiment, a beverage comprises: a food grade chelating agent in an amount from about 100 ppm to up to less than about 300 ppm; a preservative selected from the group consisting of sorbic acid, benzoic acid, alkali metal salts thereof, and mixtures thereof, in an amount from about 50 ppm to about 4000 ppm; and a beverage base. In embodiments, the beverage base may comprise a pasteurized fruit juice. In an alternative embodiment, the beverage base comprises tea solids.

The preservative may be selected from the group consisting of sorbic acid, benzoic acid, alkali metal salts thereof, and mixtures thereof. In a particular embodiment, a single preservative may be present in the beverage in the range of about 50 ppm to about 4000 ppm, more particularly about 50 ppm to about 2000 ppm, even more particularly about 50 ppm to about 1000 ppm, and still even more particularly from about 50 ppm to about 500 ppm. In another particular embodiment, a combination of preservatives are present in the beverage in an amount in the range of about 100 ppm to about 4000 ppm, more particularly from about 100 ppm to about 2000 ppm, and even more particularly from about 100 ppm to about 1000 ppm.

The food grade chelating agent may comprise a straight chain polymeric phosphate, non-limiting examples of which include sodium hexametaphosphate or potassium hexametaphosphate. In another embodiment, the food grade chelating agent may be selected from the group consisting of salts of ethylenediaminetetraacetic acid (EDTA), glucorono delta-lactone, salts of gluconic acid (e.g., sodium gluconate), and combinations thereof. In embodiments, the food grade chelating agent comprises sodium hexametaphosphate in an amount from about 100 ppm to less than about 300 ppm, more particularly from about 100 ppm to about 295 ppm, and even more particularly from about 100 ppm to about 285 ppm.

Not wishing to be bound by any theory, it is believed that the chelating agent binds the catalyst ions involved in the formation of benzene, thereby inhibiting the reaction indefinitely and preventing the formation of benzene during the beverage's shelf-life. Benzene may be formed by a number of different reagents generally present in beverages, the most common of which is the benzene derivative benzoic acid. Benzoic acid may be added to the beverage as a preservative or may be formed by other components frequently present in beverages, non-limiting examples of which include benzaldehyde and benzaldehyde acetals (naturally present in some fruits and also used as flavor additives), benzonitrile (stabilizer), or benzoyl peroxide (polymer potentiator). IN embodiments, the formation of benzene in the beverages may be inhibited such that the amount of benzene in the beverage is not greater than about 10 ppb, more particularly about 5 ppb, and still even more particularly about 1 ppb.

Other components that also may have an affect on the formation of benzene in the beverage include quinine, quassia, vanillin, anisole, and artificial azo-colorants, which may react with other components (e.g., benzoic acid) to produce benzene or which may degrade upon UV and heat exposure to produce benzene.

The beverages provided herein may comprise fruit juices originating in fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables, and tea type or favorite type beverages such as coffee, cocoa, black tea, green tea, oolong tea and the like.

In a particular embodiment, the fruit juice provided herein may be any citrus juice, non-citrus juice, or mixture thereof, which generally are known for use in beverages. Non-limiting examples of suitable fruit juices include non-citrus juices such as apple juice, grape juice, pear juice, nectarine juice, currant juice, raspberry juice, gooseberry juice, blackberry juice, blueberry juice, strawberry juice, custard-apple juice, pomegranate juice, guava juice, kiwi juice, mango juice, papaya juice, melon juices such as watermelon juice and cantaloupe juice, cherry juice, cranberry juice, pineapple juice, peach juice, apricot juice, plum juice, elderberry juice, acai juice, sea buckthorn juice, goji juice, feijo juice, boysenberry juice, fig juice, kumquat juice, lingonberry juice, lychee juice, banana juice, passion fruit juice, prune juice and mixtures thereof, and citrus juices such as orange juice, lemon juice, lime juice, grapefruit juice, tangerine juice, mandarin juice, yuzu juice, bloodorange juice, and mixtures thereof. Other fruit juices and non-fruit juices, such as vegetable or botanical juices or extracts (e.g., pumpkin, carrot, and tomato), also can be used as the juice component of the beverages provided herein. Those skilled in the art will appreciate that such fruit juices generally will be pasteurized or otherwise treated to eliminate any undesirable contaminants. Methods for pasteurization and other sterilization methods are known to those skilled in the art.

The fruit juice may be included in embodiments of the present invention to provide flavor and nutrition. The fruit juice may be any suitable fruit containing or fruit-flavored generally used for such purposes, non-limiting examples of which include a puree, comminute, single-strength, and concentrated juices. Those of ordinary skill in the art will appreciate that ascorbic acid, which reacts with benzoic acid to form benzene, is naturally present in many fruits. Accordingly, it is desirable to limit the amount of ascorbic acid present in the beverage.

In particular embodiments, the fruit juice may be present in the beverage in an amount no greater than about 50% (v/v), no greater than about 35% (v/v), no greater than about 25% (v/v), or no greater than about 20% (v/v). In other particular embodiments, wherein the fruit juice adds only flavoring to the beverage, even less fruit juice may be required in the beverage. In such embodiments, the beverage comprises no greater than about 10% (v/v) of fruit juice or no greater than about 5% (v/v) of fruit juice.

The remaining volume of the beverage generally may comprise a diluent, such as water. Those of ordinary skill in the art will appreciate that the alkalinity and hardness of the water may be modified as needed to inhibit the formation of benzene in the beverage as the degree of inhibition may be lessened in beverages comprising calcium or other minerals. Accordingly, in some embodiments the water may be stripped of its hardness using methods well known to those of ordinary skill in the art.

The beverage optionally may further comprise ascorbic acid beyond that naturally present in the fruit juice. In such embodiments, the amount of ascorbic acid added to the beverage may be less than about 100 ppm, less than about 75 ppm, or less than about 50 ppm.

In another particular embodiment, the beverage may comprise tea solids. The tea solids may be incorporated into the beverage in addition to, or in place of, the fruit juice component described hereinabove. Tea solids, as used herein, refers to solids extracted from tea materials including, but not limited to, those materials obtained from the genus Camellia, freshly gathered tea leaves, fresh green tea leaves that are dried immediately after gathering, fresh green tea leaves that have been heated before drying to inactivate any enzymes present, unfermented tea, instant green tea, and partially fermented tea leaves. The tea leaves and green tea materials include tea leaves, tea plant stems, and other plant materials which are related and which have not undergone substantial fermentation. Mixtures of unfermented and partially fermented teas also can be used. The tea solids of the beverages provided herein may be obtained by known and conventional teal solid extraction methods. In some embodiments, the tea solids may comprise caffeine, theobromine, proteins, amino acids, minerals, and carbohydrates.

The beverage optionally may further comprise a sweetener or a combination of sweeteners. Such sweeteners may be non-caloric or low-caloric, including, but not limited to, rebaudioside A, rebaudioside B, rebaudioside C, rebaudioside D, rebaudioside E, rebaudioside F, dulcoside A, dulcoside B, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I, sucralose, potassium acesulfame, aspartame, alitame, saccharin, neohesperidin dihydrochalcone, cyclamate, neotame, N-[N-[3-(3-hydroxy-4-methoxyphenyl)propyl]-L-α-aspartyl]-L-phenylalanine 1-methyl ester, N—[N-[3-(3-hydroxy-4-methoxyphenyl)-3-methylbutyl]-L-α-aspartyl]-L-phenylalanine 1-methyl ester, N—[N-[3-(3-methoxy-4-hydroxyphenyl)propyl]-L-α-aspartyl]-L-phenylalanine 1-methyl ester, salts thereof and the like. Other suitable examples of natural and/or synthetic high-potency sweeteners are disclosed in U.S. patent application Ser. Nos. 11/561,148 and 11/561,158, both filed on Nov. 17, 2006, by inventors Prakash, et al, the disclosures of which are incorporated herein by reference in their entirety. The sweeteners also may comprise natural and/or synthetic caloric sweeteners.

The beverages also may comprise other ingredients typically used in beverages. Such ingredients include flavorants, preservatives, colorants, and so forth. In addition, the beverages also may include functional ingredients that are beneficial to health. Non-limiting examples of suitable functional ingredients include phytosterols, phytostanols, and their esters, antioxidants, fibers, glucosamine, chondroitin sulfate, ginseng, ginko, Echinacea, amino acids, vitamins, minerals, carotenoids, dietary fiber, fatty acids such as omega-3 or omega-6 fatty acids, DHA, EPA, or ALA which can be derived from plant or animal sources (e.g., salmon and other cold-water fish or algae), flavonoids, phenols, polyols, polyphenols (e.g., catechins, proanthocyanidins, procyanidins, anthocyanins, quercetin, resveratrol, isoflavones, curcumin, punicalagin, ellagitannin, citrus flavonoids such as hesperidin and naringin, and chlorogenic acid), prebiotics/probiotics, phytoestrogens, sulfides/thiols, policosanol, saponin, rubisco peptide, appetite suppressants, hydration agents, autoimmune agents, C-reactive protein reducing agents, anti-inflammatory agents, or any other functional ingredient that is beneficial to the treatment of specific diseases or conditions, such as diabetes, osteoporosis, inflammation, or cholesterol.

### II. Clean Filling Lines

In some embodiments, the beverages provided herein may be cold-filled using clean filling lines designed to minimize the microbial load of the filled product. The clean filling lines comprise methods for minimizing contamination throughout the filling process, including guidelines for cleaning the containers, treating the product, and filling the containers with the treated product.

Methods of clean filling lines are well known to those of ordinary skill in the art and are disclosed in U.S. Pat. Nos. 7,143,793; 6,014,994; 5,941,290; 5,458,166; and 4,989,392, the disclosures of which are incorporated herein by reference. Briefly described, the filling process comprises cleaning the containers, filling the containers with a beverage, and capping the filled containers.

The containers of the clean filling line may be fed to a rinser via air conveyors having sterile air blowers. Upon entering the rinser, the containers may be cleaned by exposing the containers to a rinse on the interior of the container. Optionally, the rinse may be followed by residual rinsing with water on the interior of the container. In a particular embodiment the rinse comprises a chlorinated solution. For example, in a particular embodiment the chlorinated solution comprises about 2 ppm to about 3 ppm of chlorine. In another particular embodiment, the rinse comprises other suitable sanitizers such as peracetic acid or peroxide solutions. In yet another particular embodiment, an air rinser may be used. Subsequent to the containers being cleaned, the containers may be purged using nitrogen or carbon dioxide. The purging of the containers primarily serves to pressurize the container prior to filling.

The containers proceed to a filling station wherein the containers are filled with the beverages. Prior to filling, the beverages described hereinabove may be flash pasteurized using conventional methods. The filling may occur within a filling enclosure comprising microfiltered air and a positive pressure. The air in the filling enclosure is microfiltered through a filter having pore sizes of about 0.45 microns. As should be appreciated by one of ordinary skill in the art, the operator of the filler may be outside the filling enclosure. In a particular embodiment, the filler is free-standing within a small enclosure fitted with a high volume filtered air blower that achieves several air changes per minute. The positive pressure of the filling enclosure provides a simple barrier to minimize possible contamination of the containers and beverage during the filling process. One of ordinary skill in the art should appreciate that the filling of the containers with the beverages also may be performed without an enclosure, so long as appropriate steps are taken to minimize possible contamination of the containers and beverage during the filling process.

Lastly, the filled containers may be capped. The caps are exposed to ionized air to remove particles immediately prior to being placed on the containers filled with the flash pasteurized beverage. In another embodiment the caps may be rinsed with a chlorinated solution in place of the ionized air or in combination with the ionized air.

The cold-filled containers may be held for at least five days in quarantine until tests conducted on samples taken throughout the clean filling process confirm microbial stability, particularly the microbial stability with respect to preservative resistant microorganisms. Non-limiting examples of suitable samples include samples of the flash pasteurized beverage at different points of the filling process and both raw and rinse water used to clean the containers, filler, and fill lines.

The clean filling line also may comprises a means for cleaning in place at least about every 12 to about every 48 hours, more particularly every about 12 to about every 36 hours, and even more particularly every 24 hours. In addition, the interior of the filling lines desirably may be rinsed with hot water at a temperature of about 85° C. at least once every day or at least after every flavor change.

The exterior of the filler may be cleaned with a detergent sanitizer to maintain external microbiological standards at least about every 6 to about every 72 hours, more particularly every about 12 to every about 24 hours. In addition, the filler valves of the filler may be sprayed with chlorinated water for about one to about five minutes, more particularly about one to about three minutes, and even more particularly about two minutes. The filler valves may be sprayed and/or flushed with chlorinated water or other suitable sanitizers (e.g., peracetic acid or peroxide) to maintain low levels of microbial infection at least about every two hours of the filling process. Those of ordinary skill in the art should appreciate that the filling process is briefly interrupted during the cleaning of the filler and filler valves. Those of ordinary skill in the art also should appreciate that the frequency and duration of cleaning the filling line, filler, and filler valves may be increased or decreased depending on the beverage being filled and the required level of cleanliness.

The present invention provides an improvements over the prior art methods of filling and preserving beverages. By reducing the amount of food grade chelating agents to up to less than about 300 ppm and implementing a clean filling process, it is possible to control microbial proliferation while also inhibiting or reducing the rate of benzene formation.

Reference now will be made in detail to the presently proffered embodiments of the invention. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment, can be used on another embodiment to yield a still further embodiment. Thus, it is intended that the present invention cover such modifications and variations within the scope of the appended claims and their equivalents.

### EXAMPLES

### Example 1

A citrus punch is provided comprising about 285 ppm sodium hexametaphosphate, about 157 ppm sorbic acid, about 137 ppm benzoic acid, 5% (v/v) pasteurized citrus juice, 4.5 brix, and a combination of the sweeteners aspartame and acesulfame potassium.

### Example 2

The effect of sodium hexametaphosphate on inhibiting the formation of benzene in beverages was measured for fresh beverages, beverages illuminated in a UV chamber (400 and 800 Langley), and beverages stored at 50° C. for 5 and 10 days. The beverages comprised 136 ppm benzoic acid, 224 ppm sorbic acid, 5% (v/v) of 4.5° Brix fruit juice derived from mixtures of fruit juices including blackcurrant, apple, blackberry, raspberry, summer fruits such as cherry, redcurrant, and strawberry, or citrus fruits such as lemon, mandarin, and orange, and either 800, 285, or 0 ppm of sodium hexametaphosphate. The results are described in the following table.

TABLE 1
Effect of sodium hexametaphosphate on the inhibition of
benzene formation for a mixture of fruit juices derived
from blackcurrant, apple, blackberry, and raspberry

| | Benzene (ppb) | Benzene (ppb) | Benzene (ppb) |
|---|---|---|---|
| Aging/Condition | (800 ppm SHMP) | (285 ppm SHMP) | (0 ppm SHMP) |
| Fresh | <0.5 | <0.5 | <0.5 |
| UV - 400 L | <0.5 | <0.5 | 0.9 |
| 5 days @ 50° C. | <0.5 | <0.5 | 3.4 |

TABLE 2
Effect of sodium hexametaphosphate on the inhibition of benzene
formation for a mixture of fruit juices derived from summer fruits,
including apple, cherry, redcurrant, and strawberry

| | Benzene (ppb) | Benzene (ppb) | Benzene (ppb) |
|---|---|---|---|
| Aging/Condition | (800 ppm SHMP) | (285 ppm SHMP) | (0 ppm SHMP) |
| Fresh | <0.5 | <0.5 | <0.5 |
| UV - 400 L | <0.5 | <0.5 | 1.0 |
| 5 days @ 50° C. | <0.5 | <0.5 | 3.0 |

TABLE 3
Effect of sodium hexametaphosphate on the inhibition of
benzene formation for fruit juice derived from a mixture
of citrus fruits including lemon, mandarin, and orange

| | Benzene (ppb) | Benzene (ppb) | Benzene (ppb) |
|---|---|---|---|
| Aging/Condition | (800 ppm SHMP) | (285 ppm SHMP) | (0 ppm SHMP) |
| Fresh | <0.5 | <0.5 | <0.5 |
| UV - 400 L | <0.5 | <0.5 | 0.6 |
| 5 days @ 50° C. | <0.5 | <0.5 | 1 |

The results indicate that SHMP limits benzene formation in fruit juice beverages. Surprisingly, even low levels of SHMP were found to be effective in reducing the amount of benzene formation in beverages.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

We claim:

1. A beverage comprising:
a food grade chelating agent in an amount from about 100 ppm to up to less than about 300 ppm;
a preservative selected from the group consisting of sorbic acid, benzoic acid, alkali metal salts thereof, and combinations thereof, in an amount from about 50 ppm to about 4000 ppm; and
a beverage base comprising a fruit juice.

2. The beverage of claim 1, wherein the food grade chelating agent is present in an amount from about 100 ppm to about 295 ppm.

3. The beverage of claim 1, wherein the food grade chelating agent is present in an amount from about 100 ppm to about 285 ppm.

4. The beverage of claim 1, wherein the food grade chelating agent is selected from the group consisting of sodium hexametaphosphate, potassium hexametaphosphate, ethylenediaminetetraacetic acid, glucorono delta-lactone, salts of gluconic acid, and combinations thereof.

5. The beverage of claim 1, wherein the fruit juice is present in the beverage in an amount no greater than about 50% by volume.

6. The beverage of claim 1, wherein the fruit juice is present in the beverage in an amount no greater than about 35% by volume.

7. The beverage of claim 1, wherein the fruit juice is present in the beverage in an amount no greater than about 25% by volume.

8. The beverage of claim 1, wherein the fruit juice is present in the beverage in an amount no greater than about 20% by volume.

9. The beverage of claim 1, wherein the pasteurized fruit juice is present in the beverage in an amount no greater than about 10% by volume.

10. The beverage of claim 1, comprising benzene in an amount not greater than about 10 ppb.

11. The beverage of claim 1, comprising benzene in an amount not greater than about 5 ppb.

12. The beverage of claim 1, comprising benzene in an amount not greater than about 1 ppb.

13. The beverage of claim 1, further comprising at least one sweetener.

14. A beverage comprising:
a food grade chelating agent in an amount from about 100 ppm to up to less than about 300 ppm;
a preservative selected from the group consisting of sorbic acid, benzoic acid, alkali metal salts thereof, and combinations thereof, in an amount from about 50 ppm to about 4000 ppm; and
a beverage base comprising tea solids.

15. The beverage of claim 14, wherein the food grade chelating agent is present in an amount from about 100 ppm to about 295 ppm.

16. The beverage of claim 14, wherein the food grade chelating agent is present in an amount from about 100 ppm to about 285 ppm.

17. The beverage of claim 14, wherein the food grade chelating agent is selected from the group consisting of sodium hexametaphosphate, potassium hexametaphosphate, ethylenediaminetetraacetic acid, glucorono delta-lactone, salts of gluconic acid, and combinations thereof.

18. The beverage of claim 14, comprising benzene in an amount not greater than about 10 ppb.

19. The beverage of claim 14, comprising benzene in an amount not greater than about 5 ppb.

20. The beverage of claim 14, comprising benzene in an amount not greater than about 1 ppb.
